(19) United States
(12) Patent Application Publication
(10) Pub. No.: US 2013/0028167 A1
(43) Pub. Date: Jan. 31, 2013

(54) MULTIPLE-HOP MULTI-INPUT MULTI-OUTPUT AMPLIFY-AND-FORWARD RELAY WIRELESS COMMUNICATION SYSTEM AND METHOD APPLICABLE THERETO

(71) Applicants: Chao-Kai Wen, Kaohsiung City (TW); Jung-Chieh Chen, Meishan Township (TW); Jing-Yu Chen, Taichung City (TW); Jiun-Yo Lai, Taichung City (TW); Pang-An Ting, Taichung City (TW)

(72) Inventors: Chao-Kai Wen, Kaohsiung City (TW); Jung-Chieh Chen, Meishan Township (TW); Jing-Yu Chen, Taichung City (TW); Jiun-Yo Lai, Taichung City (TW); Pang-An Ting, Taichung City (TW)

(73) Assignee: INDUSTRIAL TECHNOLOGY RESEARCH INSTITUTE, HSINCHU (TW)

(21) Appl. No.: 13/309,458

(22) Filed: Dec. 1, 2011

(30) Foreign Application Priority Data
Jul. 27, 2011 (TW) 100126652

(51) Int. Cl. H04B 7/14; H04W 72/04; H04W 40/00

(52) U.S. Cl. 370/315

(57) ABSTRACT

A multiple-hop multi-input multi-output (MIMO) amplify-and-forward relay wireless communication system includes a signal source node, a signal destination node and a plurality of relay nodes, wirelessly coupled between the signal source node and the signal destination node. The relay nodes feed back a plurality of signal to noise ratio information and a plurality of antenna number information to the signal source node. The signal source node allocates a plurality of corresponding transmission powers for the relay nodes and sends to the relay nodes.

This application claims the benefit of Taiwan application Serial No. 100126652, filed Jul. 27, 2011, the disclosure of which is incorporated by reference herein in its entirety.

### TECHNICAL FIELD

The disclosed embodiments relate in general to a wireless communication system and a method applicable thereto.

### BACKGROUND

The quality of long distance wireless communication may deteriorate due to the obstacles. If a relay terminal (RT) is located between a source terminal (ST) and a destination terminal (DT), the quality of long distance wireless communication will thus be improved. Normally, the relay terminal is low cost and low power consumption. The relay terminal is also referred as a hop.

To increase the spectral efficiency and the communication capacity for the system, the relay terminal is now combined with multiple-input multiple-output (MIMO) technology. The multiple-hop MIMO amplify-and-forward (AF) relay technology, which is simple and easy to implement, has attracted a lot of interests.

### BRIEF SUMMARY

The present disclosure is directed to a multiple-hop multiple-input multiple-output (MIMO) amplify-and-forward relay wireless communication system and a method thereof which generate a precoding matrix.

The present disclosure embodiment is related to a multiple-hop MIMO amplify-and-forward relay wireless communication system and a method which achieve low transmission power consumption while maintain the target data rate.

The present disclosure embodiment is related to a multiple-hop MIMO amplify-and-forward relay wireless communication system and a method which select one among a plurality of wireless signal link paths to increase the wireless communication system capacity.

The present disclosure embodiment is related to a multiple-hop MIMO amplify-and-forward relay wireless communication system and a method which optimize the wireless communication transmission capacity under fixed transmission power consumption.

According to an exemplary embodiment of the present disclosure, a multiple-hop multiple-input multiple-output (MIMO) amplify-and-forward relay wireless communication system is provided. The wireless communication system includes a signal source node; a signal destination node, and a plurality of relay nodes. The relay nodes, wirelessly coupled between the signal source node and the signal destination node, feedback a plurality of signal to noise ratio information and a plurality of antenna number information to the signal source node. The signal source node allocates a plurality of corresponding transmission powers of the relay nodes and transfers the corresponding transmission powers to the relay nodes.

According to another exemplary embodiment of the present disclosure, a multiple-hop MIMO amplify-and-forward relay wireless communication method applicable to a wireless communication system is provided. The wireless communication system comprises a signal source node, a signal destination node and a plurality of relay nodes. The relay nodes are wirelessly coupled between the signal source node and the signal destination node. The wireless communication method includes the following steps. A plurality of signal to noise ratio information and a plurality of antenna number information are fed back to the signal source node by the relay nodes. A plurality of corresponding transmission powers of the relay nodes are allocated and transferred to the relay nodes by the signal source node.

It is to be understood that both the foregoing general description and the following detailed description are exemplary and explanatory only and are not restrictive of the disclosed embodiments, as claimed.

### BRIEF DESCRIPTION OF THE DRAWINGS

FIG. 1 shows a schematic diagram of a wireless communication system according to the present disclosure embodiment;

FIG. 2 shows signal flow of implementations 1 and 2 according to the present disclosure embodiment;

FIG. 3 shows a flowchart of implementations 1 and 2 according to the present disclosure embodiment; and

FIG. 4 shows a schematic diagram of multiple communication link paths of the wireless communication system according to the present disclosure embodiment.

### DETAILED DESCRIPTION OF THE DISCLOSURE

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

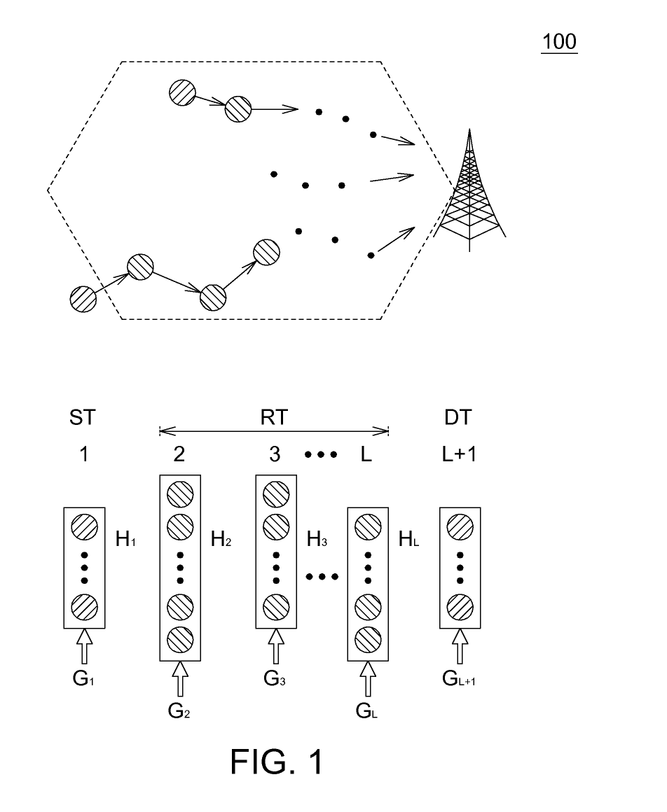

Referring to FIG. 1, a schematic diagram of a wireless communication system according to the present disclosure embodiment is shown. As indicated in FIG. 1, the wireless communication system 100 includes a source terminal (or referred as a signal source node) ST, a destination terminal (or referred as a signal destination node) DT and a plurality of relay terminals (or referred as relay nodes) RT. The source terminal ST, the destination terminal DT and the relay terminals RT may also be referred as nodes. Therefore, the source terminal ST is also referred as a node 1; the relay terminals RT are also referred as nodes 2˜L (L is a positive integer larger than or equal to 2), and the destination terminal (DT is also referred as a node L+1. The relay terminals RT are wirelessly coupled to and between the source terminal ST and the destination terminal DT. Antenna numbers N_{I} are allocated to the nodes 1˜L+1 respectively, wherein N_{I} (I=1, . . . , L+1) is a positive integer larger than or equal to 1.

In FIG. 1, H denotes a channel between nodes, which is represented in a matrix. For example, H₁ denotes a channel between node 1 (ST) and node 2 (RT), and the rest can be obtained by analogy. In addition, G₁˜G_{L} respectively denote the precoding matrixes of nodes 1˜L.

The signal x₁ transmitted from the node 1 (ST) may be represented a vector as:

x₁=G₁s (1)

Wherein, s denotes an original source signal, G₁εC^{N}^{₁}^{×N}^{₁} denotes the precoding matrix of the node 1.

The signal yₗ received by the l-th node may be expressed as:

yₗ=Hₗ₋₁xₗ₋₁+zₗ, l=2, . . . , L+1 (2)

Wherein, Hₗ₋₁εC^{N}^{₁}^{×N}^{_{l−1}} denotes a multiple-input multiple-output (MIMO) channel matrix between the l-th node and the (l−1)^{th} node; zₗεC^{N}^{ₗ} denote a complex white Gaussian noise vector with zero mean and covariance matrix I_{N}_{ₗ}, which I_{N}_{ₗ} denotes an identity matrix with Nₗ dimensions. Xₗ₋₁εC^{N}^{_{l−1}} denotes a signal vector transmitted from the (l−1)^{th} node. The matrix elements of the channel matrix Hₗ are complex independent identical distributions (i.i.d) which are statistically independent and have the same zero mean and the same variance

$$\frac{{ρ}_{l}}{{N}_{l}}$$

with ρₗ being a signal to noise ratio (SNR) between the l-th node and the (l−1)^{th} node.

The l-th node multiplies the received signal by a precoding matrix GₗεC^{N}^{ₗ}^{×N}^{ₗ} and transfers forward. The signal xₗ transferred from the l-th node may be expressed as:

xₗ=Gₗyₗ, l=2, . . . , L. (3)

For convenience of representation, the representation may be expressed as: Φ_{l:1} [symbol] HₗGₗ . . . H₁G₁.

The above formulas (1)˜(3) are re-arranged, and the signal received in the node L+1 (DT) may be expressed as:

y=Hs+z (4)

Wherein,

$$\begin{matrix} H = {H}_{L} {G}_{L} … {H}_{1} {G}_{1} = {Φ}_{L : 1} & ( 5 ) \\ z = {H}_{L} {G}_{L} … {H}_{2} {G}_{2} {z}_{2} + … + {H}_{L} {G}_{L} {z}_{L} + {z}_{L + 1} = {\sum }_{l = 2}^{L} {Φ}_{L : l} {z}_{l} + {z}_{L + 1} & ( 6 )\end{matrix}$$

The linear precoding matrix obtained from the principles of singular value decomposition (SVD) makes the multiple-hop multiple-input multiple-output (MIMO) amplify-and-forward relay wireless communication system achieve system channel capacity, and detailed descriptions of the SVD-based precoding method are given below.

After the SVD is performed on the channel Hₗ, Hₗ may be expressed as:

Hₗ=UₗΣₗVₗ⁺, l=2, . . . , L (7)

Wherein, UₗεC^{N}^{ₗ₊₁}^{×N}^{ₗ₊₁} and VₗεC^{N}^{ₗ}^{×N}^{ₗ} both are unitary matrixes, each ΣₗεC^{N}^{ₗ₊₁}^{×N}^{ₗ} is a diagonal matrix whose k^{th} diagonal element is \sqrt{λ_{l,k}}. Since matrixes Uₗ and Vₗ are obtained by performing SVD on the channel Hₗ, the matrixes Uₗ and Vₗ are referred as channel representation matrixes here below.

To achieve the wireless communication system capacity, the precoding matrix may be expressed as:

G₁=V₁Σ_{g1} (8)

Gᵢ=VᵢΣ_{g1}Uᵢ₋₁⁺i=2, . . . , L (9)

Wherein, both the matrix Σ_{g}_{₁} and the matrix Σ_{g}_{ₗ} are diagonal matrixes.

$${\sum }_{{g}_{1}} = [ \begin{matrix}\sqrt{{g}_{1 , 1}} & 0 & … & 0 \\ 0 & \sqrt{{g}_{1 , 2}} & ⋱ & ⋮ \\ ⋮ & ⋱ & ⋱ & 0 \\ 0 & … & 0 & \sqrt{{g}_{1 , {N}_{l}}}\end{matrix} ]$$

$${\sum }_{{g}_{l}} = [ \begin{matrix}\sqrt{{g}_{l , 1}} & 0 & … & 0 \\ 0 & \sqrt{{g}_{l , 2}} & ⋱ & ⋮ \\ ⋮ & ⋱ & ⋱ & 0 \\ 0 & … & 0 & \sqrt{{g}_{l , {N}_{l}}}\end{matrix} ]$$

The present disclosure embodiment has four exemplary embodiments respectively disclosed below.

### Exemplary Embodiment 1

### Adjustment of Wireless Communication System Capacity

The adjustment of the wireless communication system capacity such as but not limited to maximizing the wireless communication system capacity. The diagonal elements of the matrix Σ_{g}_{₁} are identical and proportional to each node transmission power, and so is the matrix Σ_{g}_{ₗ}. Thus, for the nodes ST and RT, the diagonal elements of the matrix Σ_{g}_{₁} and matrix Σ_{g}_{ₗ} may be expressed as:

$$ST \text{:} \sqrt{{g}_{1 , 1}} = \sqrt{{g}_{1 , 2}} = … = \sqrt{{g}_{1 , {N}_{1}}} ∝ \frac{{P}_{1}}{K}$$

$$RT \text{:} \sqrt{{g}_{l , 1}} = \sqrt{{g}_{l , 2}} = … = \sqrt{{g}_{l , {N}_{l}}} ∝ \frac{{P}_{l}}{K} , l = 2 , … , L$$

Wherein, K denotes the number of data streams and is smaller or equal to the minimum of N₁˜N_{L+1}.

Thus, in exemplary embodiment 1, the process for adjusting the wireless communication system capacity is disclosed as follows. The channel representation matrix Vₗ is fed back to the previous node, for example, as the above descriptions, wherein SVD is performed on the channel Hₗ to obtain a channel representation matrix Vₗ. Let the transmission power for each node be Pₗ, and the diagonal matrix Σ_{g}_{ₗ} of each node is calculated according to the above descriptions. Based on the above formulas (8) and (9), the precoding matrix Gₗ of each node is obtained according to Vₗ and Σ_{g}_{ₗ} to adjust the wireless communication system capacity. For example, the wireless communication system capacity is adjusted as the maximum.

In the adjustment of the wireless communication system capacity as indicated in exemplary embodiment 1, the transmission power for each node may be the same or different, and may further be determined according to the process disclosed in exemplary embodiment 2.

### Exemplary Embodiment 2

### Power Allocation

The following descriptions are related to reduce system power consumption while maintain the target data rate, which is an optimization solution. In the process of resolving the optimization solution, it is found that the transmission power Pₗ for each node is related to a signal to noise ratio (SNR) at each node and an antenna number at each node. The power allocation process of the exemplary embodiment 2 of the present disclosure is as follows. The signal to noise ratios and the antenna numbers at all nodes are fed back to the node 1 (ST). The node 1 (ST) resolves the optimization solution to calculate the transmission power Pₗ for each node. Exemplarily but not restrictively, the optimization solution may be resolved according to a geometric programming (GP) to simplify the calculation of the transmission power Pₗ for each node. The obtained node transmission power Pₗ is transferred forward to each node by the node 1 (ST). Respective precoding matrix is updated by the respective relay node according to the node transmission power Pₗ calculated by the node 1 (ST). In exemplary embodiment 2, the process for updating precoding matrix may be implemented by such as but not limited to the process disclosed in exemplary embodiment 1.

That is, in exemplary embodiment 2 of the present disclosure, the required power allocation may be determined according to the signal to noise ratios and the antenna numbers at all nodes.

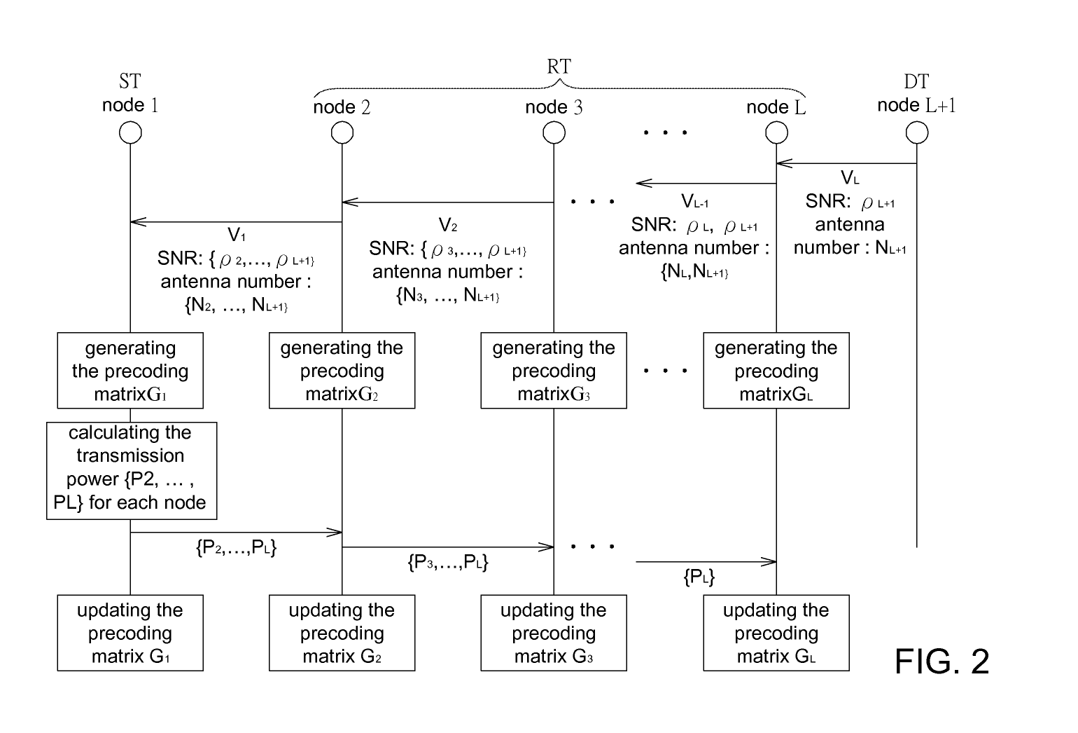

For detailed descriptions of the exemplary embodiment 1 and the exemplary embodiment 2 of the present disclosure, please referring to FIG. 2 which shows a signal flow of exemplary embodiments 1 and 2 according to the present disclosure embodiment is shown. The node L+1 (DT) transfers its own channel representation matrix V_{L}, its own SNR information ρ_{L+1} and its own antenna number information N_{L+1} forward to the node L. Likewise, the node L (RT) transfers its own channel representation matrix V_{L-1}, its own SNR information and the collected SNR information {ρ_{L},ρ_{L+1}}, and, its own antenna number information and collected antenna number information {N_{L},N_{L+1}} forward to the node L−1. By the same analogy, the node 2 (RT) transfers its own matrix V₁, its own SNR information and the collected SNR information {ρ₂, . . . , ρ_{L+1}}, and, its own antenna number information and the collected antenna number information {N₂, . . . , N_{L+1}} forward to the node 1 (ST).

The node L generates the precoding matrix G_{L} according to the matrix V_{L}, the SNR information {ρ_{L},ρ_{L+1}}, and the antenna number information {N_{L},N_{L+1}}. Likewise, the nodes 1˜L−1 respectively generate precoding matrixes G₁˜G_{L-1}.

As disclosed in the above exemplary embodiment 2, the node 1 (ST) calculates the transmission powers {P₂, . . . , P_{L}} for each node, and transfers the node transmission powers {P₂, . . . , P_{L}} to the node 2. As disclosed in the above exemplary embodiment 1, the node 1 (ST) updates its own precoding matrix G₁.

Likewise, the node 2 receives the node transmission powers {P₂, . . . , P_{L}} transferred from the node 1, fetches its own necessary transmission power P₂, and transfers the subsequent node transmission powers {P₃, . . . , P_{L}} to the node 3. Likewise, as disclosed in the above exemplary embodiment 1, the node 2 (RT) updates its own precoding matrix G₂. By the same analogy, the nodes 2˜L receive the node transmission powers transferred from the previous node, fetch their own necessary transmission powers, and transfer the subsequent node transmission powers to the next node, and update their own precoding matrixes.

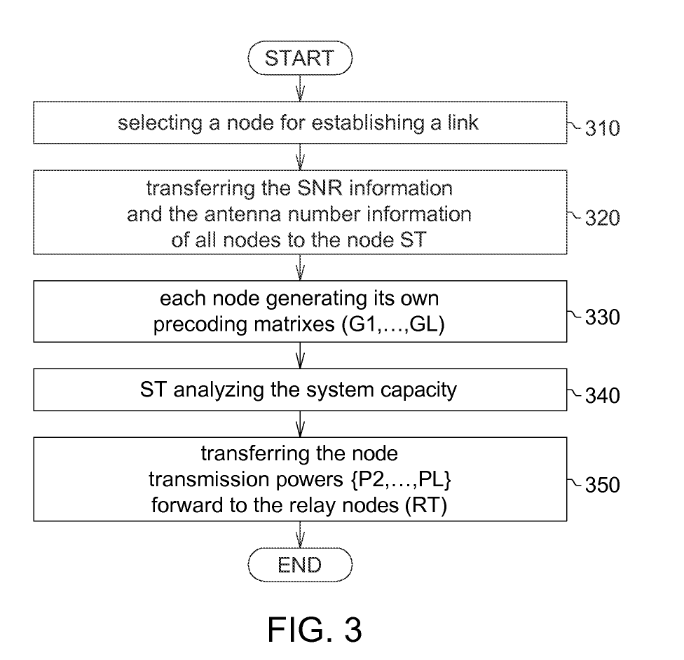

Referring to FIG. 3, a flowchart of exemplary embodiments 1 and 2 according to the present disclosure embodiment is shown. In step 310, a node (or a relay) is selected for establishing a link. The relay node may be selected according to the exemplary embodiment 3 of the present disclosure embodiment or selected in advance by a predetermined rule.

In step 320, the SNR information and the antenna number information for all nodes are transferred to the node ST as indicated in FIG. 2. The matrix Vₗ of the next node may be transferred forward to the previous node as indicated in FIG. 2.

In step 330, the nodes generate their own precoding matrixes (G₁, . . . , G_{L}) respectively, and the details are as indicated in the above disclosure.

In step 340, the system capacity is analyzed by the signal source node ST according to the collected SNR information and the collected antenna number information, and the details are disclosed in the above exemplary embodiment 1. After analyzing the system capacity, the signal source node ST calculates the transmission power for each node.

In step 350, the node transmission powers {P₂, . . . , P_{L}} are transferred forward to the relay nodes (RT), and the details are as indicated in FIG. 2.

### Exemplary Embodiment 3

### Selection of Communication Link Path

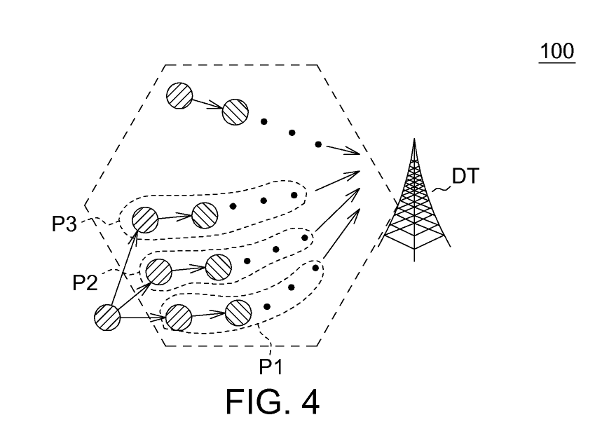

In the multiple-hop MIMO amplify-and-forward relay wireless communication system, it is allowable to select different relays as a bridge for transferring the source signal to the destination. The selected relays, the source terminals and the destination terminal form a communication link path. Thus, the multiple-hop MIMO amplify-and-forward relay wireless communication system may have multiple communication link paths. As indicated in FIG. 4, if a signal is transferred by a node ST, there are several possible relay transmission link paths to send this signal. In FIG. 4, three link paths P₁˜P₃ are illustrated for exemplification purpose. However, anyone who is skilled in the technology of the present disclosure will understand that the present disclosure is not limited thereto. In exemplary embodiment 3 of the present disclosure embodiment, one link path among the link paths is selected to for example but not limited to maximize the wireless communication system capacity.

The process for selecting the link path is as follows. The SNR and the antenna numbers for all nodes on each link path are transferred to the node 1 (ST). Corresponding wireless communication system capacity of each link path is evaluated. One communication link path is selected among the communication link paths for transferring the wireless communication signal, wherein the link path is selected in a manner such as but not limited to making the wireless communication system capacity maximized.

In exemplary embodiment 3, the process of evaluating the corresponding wireless communication system capacity of each link path may be implemented according to such as but not limited to the disclosure of exemplary embodiment 1. In exemplary embodiment 1, the wireless communication system capacity may be adjusted in a manner such as but not limited to making the wireless communication system capacity maximized, and the details are not repeated here.

### Exemplary Embodiment 4

### Adjustment of the Data Transfer Rate of the Wireless Communication System

In exemplary embodiment 4 of the present disclosure, under the circumstance that the node transmission power is restricted or fixed, the data transfer rate of the wireless communication system is adjusted in a manner such as but not limited to making the data transfer rate of the wireless communication system maximized, which is an optimization solution.

The process for adjusting the wireless communication system data transfer rate is as follows. The SNR and the antenna numbers for all nodes are transferred to the node 1 (ST). The node 1 (ST) resolves the optimization solution to calculate corresponding data transfer rate of each signal stream. In the present disclosure embodiment, exemplarily but not restrictively, the optimization solution may be resolved according to the geometric programming (GP) for simplifying the calculation of the corresponding data transfer rate of each signal stream, such that the data transfer rate of the wireless communication system (which is the sum of the data transfer rate of each signal stream of the wireless communication system) is maximized.

In exemplary embodiment 4, the process for obtaining/calculating/evaluating corresponding data transfer rate of the wireless communication system of each signal stream may be implemented according to the process disclosed in exemplary embodiment 1, and the details are not repeated here.

According to the embodiments of the present disclosure, in exemplary embodiment 1, the channel representation matrix is transferred to the previous node to obtain the precoding matrix to adjust the wireless communication system capacity (such as but not limited to making the wireless communication system capacity maximized). In exemplary embodiments 2˜4, the SNR and the antenna numbers of all nodes are transferred to the signal source node, so that the transmission power may be reduced while the target data rate is maintained, and/or the communication link path which maximizes the wireless communication system capacity may be selected in transferring wireless signal, and/or the wireless communication system capacity is maximized under the circumstance that the transmission power is fixed.

It will be appreciated by those skilled in the art that changes could be made to the disclosed embodiments described above without departing from the broad inventive concept thereof. It is understood, therefore, that the disclosed embodiments are not limited to the particular examples disclosed, but is intended to cover modifications within the spirit and scope of the disclosed embodiments as defined by the claims that follow.

What is claimed is:

1. A multiple-hop multiple-input multiple-output (MIMO) amplify-and-forward relay wireless communication system, comprising:
a signal source node;
a signal destination node; and
a plurality of relay nodes coupled between the signal source node and the signal destination node;
wherein, the relay nodes feedback a plurality of signal to noise ratio information and a plurality of antenna number information to the signal source node and the signal source node allocates a plurality of corresponding transmission powers of the relay nodes and transfers the corresponding transmission powers to the relay nodes.

2. The wireless communication system according to claim 1, wherein the signal source node and the relay nodes update a plurality of corresponding precoding matrix according to the node powers allocated by the signal source node.

3. The wireless communication system according to claim 2, wherein the relay nodes transfers the signal to noise ratio information and the antenna number information forward.

4. The wireless communication system according to claim 3, wherein the relay nodes transfer a channel representation matrix of its own forward.

5. The wireless communication system according to claim 4, wherein, the relay nodes fetches a corresponding transmission power from the received node transmission powers and transfer the node transmission powers backward.

6. The wireless communication system according to claim 4, wherein, the signal source node, the relay nodes and the signal destination node update the precoding matrixes to adjust a system data transfer rate of the wireless communication system.

7. The wireless communication system according to claim 6, wherein,
the signal source node evaluates at least one possible system data transfer rate corresponding to at least one signal transmission communication link path; and
the signal source node selects one among the signal transmission communication link paths for transmitting a wireless communication signal to adjust the system data transfer rate of the wireless communication system.

8. The wireless communication system according to claim 6, wherein,
under a circumstance that the node transmission powers are restricted or fixed, the signal source node calculates a corresponding data transfer rate of each signal stream to adjust the system data transfer rate of the wireless communication system.

9. A multiple-hop multiple-input multiple-output (MIMO) amplify-and-forward relay wireless communication method applicable to a wireless communication system, the wireless communication system comprising a signal source node, a signal destination node, and a plurality of relay nodes wireless coupled between the signal source node and the signal destination node, the wireless communication method comprising:
feedbacking a plurality of signal to noise ratio information and a plurality of antenna number information to the signal source node by the relay nodes; and
allocating a plurality of corresponding transmission powers of the relay nodes and transferring the corresponding transmission powers to the relay nodes by the signal source node.

10. The wireless communication method according to claim 9, wherein, the signal source node and the relay nodes update a plurality of corresponding precoding matrix according to the node powers allocated by the signal source node.

11. The wireless communication method according to claim 10, wherein, the relay nodes transfer the signal to noise ratio information and the antenna number information forward.

12. The wireless communication method according to claim 11, wherein, the relay nodes transfer a channel representation matrix of its own forward.

13. The wireless communication method according to claim 12, wherein, the relay nodes fetch a corresponding transmission power from the received node transmission powers and transfer the node transmission powers backward.

14. The wireless communication method according to claim 13, wherein, the signal source node, the relay nodes and the signal destination node update the precoding matrixes to adjust a system data transfer rate of the wireless communication system.

15. The wireless communication method according to claim 14, wherein,
the signal source node evaluates at least one possible system data transfer rate corresponding to at least one signal transmission communication link path; and
the signal source node selects one among the signal transmission communication link paths for transmitting a wireless communication signal to adjust the system data transfer rate of the wireless communication system.

16. The wireless communication method according to claim 14, wherein,
calculating a corresponding data transfer rate of each signal stream by the signal source node to adjust the system data transfer rate of the wireless communication system under a circumstance that the node transmission powers are restricted or fixed.
